(19) United States
(12) Patent Application Publication
(10) Pub. No.: US 2025/0381823 A1
(43) Pub. Date: Dec. 18, 2025

(54) THERMAL MANAGEMENT MODULE FOR A VEHICLE

(71) Applicant: MAHLE INTERNATIONAL GMBH, Stuttgart (DE)

(72) Inventors: Tobias ISERMEYER, Löwenstein (DE); Felipe ASTORRI, Abweiler G.D. (LU); Markus BOGER, Stuttgart (DE); Robin WANKE, Puzol (ES); Dominik BEHNERT, Leonberg (DE); Collin REFORMAT, Depew, NY (US); Lawrence P. SCHERER, Lockport, NY (US); Jonathan K. HAMMOND, Churchville, NY (US)

(21) Appl. No.: 19/089,275

(22) Filed: Mar. 25, 2025

Related U.S. Application Data
(60) Provisional application No. 63/661,231, filed on Jun. 18, 2024.
(60) Provisional application No. 63/665,059, filed on Jun. 27, 2024.

(51) Int. Cl. B60H 1/32

(52) U.S. Cl. CPC B60H 1/3226; B60H 1/3227; B60H 1/3228; B60H 2001/3292

(57) ABSTRACT

A thermal management module is provided. The thermal management module includes a housing that encloses a compressor, the housing fixedly retaining a condenser, an expansion device, and a chiller. The housing integrally forms a plurality of flowpaths within the housing that are configured for refrigerant to flow therethrough, including a first flow path from a discharge of the compressor to an inlet of the condenser, a second flow path from the expansion device to an inlet of the chiller, and a third flow path from the chiller to a suction of the compressor, wherein each of the first flow path, the second flow path, and the third flow path are each integrally formed within the housing.

### CROSS-REFERENCE TO RELATED APPLICATIONS

This application claims priority from U.S. Provisional Patent Application No. 63/661,231, filed on Jun. 18, 2024, and from U.S. Provisional Patent Application No. 63/665,059, filed on Jun. 27, 2024, the entirety of each are hereby incorporated by reference herein.

### BACKGROUND

Thermal management modules are modules that include all or a significant portion of the components within a refrigeration system that are fixed together. Thermal management modules are connected as a single unit such that the thermal management module can be installed within a vehicle or machine that will include HVAC functionality as a single installation step.

### BRIEF SUMMARY

A representative embodiment of the disclosure is provided. The embodiment includes a thermal management module. The thermal management module can be within a vehicle, such as a passenger vehicle (sedan, SUV, truck) or within a machine like a tractor or a crane, or other types of equipment where controllable heating or cooling is desired for a passenger or operator space or for equipment. The thermal management module includes a housing that encloses a compressor, the housing fixedly retaining a condenser, an expansion device, and a chiller. The housing is integrally formed with a plurality of flowpaths within the housing that are configured for refrigerant to flow therethrough, including a first flow path from a discharge of the compressor to an inlet of the condenser, a second flow path from the expansion device to an inlet of the chiller, and a third flow path from the chiller to a suction of the compressor, wherein each of the first flow path, the second flow path, and the third flow path are each integrally formed within the housing.

Other representative embodiments are provided that are in the form of one or more of the Representative Paragraphs provided at the end of this specification.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a side cross-sectional view of a thermal management module, that depicts the compressor, condenser, subcooler, receiver/dryer, expansion valve, and chiller each enclosed within the housing and the various fluid connections within the housing for refrigerant to cyclically flow therealong that are integrally formed from the housing.

FIG. 2 is a top cross-sectional view of section Z-Z of FIG. 1.

FIG. 3 is a perspective view of a prior art thermal management module.

### DETAILED DESCRIPTION

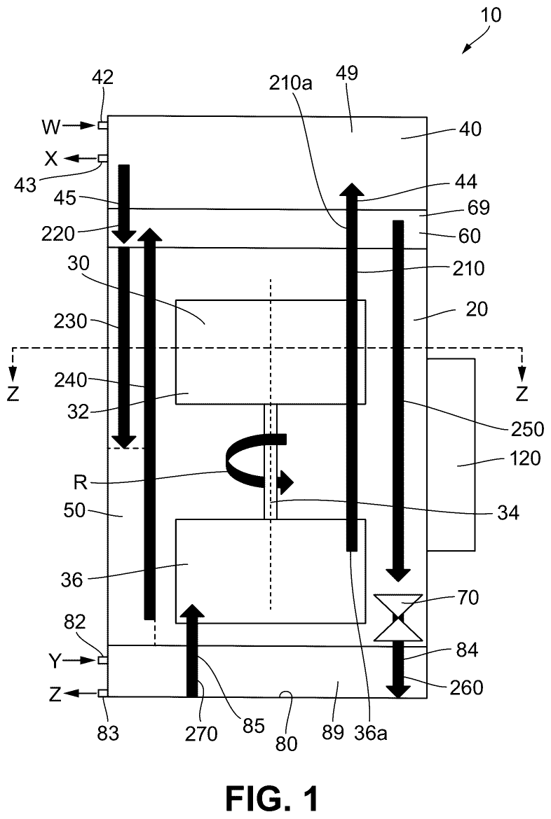

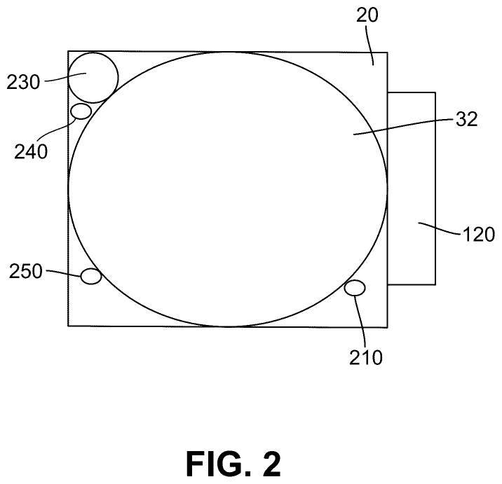

Turning now to FIGS. 1-2 a thermal management module 10 is provided. Thermal management modules are frequently used within cars or trucks or other vehicles or machines that either have a passenger compartment (such as a tractor or a crane) and/or have a need to keep a portion of the machine in a climate controlled fashion. While thermal management modules may be successfully employed with various types of vehicles or machines, this specification, for the sake of brevity will discuss the inventive thermal management module 10 as configured to be provided within a passenger vehicle, such as a car. A reader of at least ordinary skill in the art with a thorough review and understanding of this specification would readily understand how to implement the disclosed thermal management module 10 in other vehicles or machines without undue experimentation.

Thermal management modules 10 are assemblies that include all of the components of a typical refrigeration cycle, such as the components of a refrigeration cycle that are used within a vehicle's HVAC system to control the temperature of air within a vehicle's passenger compartment, or to provide thermally controlled air, such as for a vehicle defrost or defog system. A thermal management module typically includes some or all of the components of a refrigeration system, such as a compressor, a condenser, and an evaporator, which selectively, and based upon how the thermal management module is installed within the vehicle can provide heat or cooling for the air within the HVAC system. Thermal management modules typically are a single unit that can be installed into a vehicle as a single unit, with the installation involving fixing the thermal management module in place within the vehicle, connecting the various coolant connections (or other fluid connections with the vehicle or the systems within a vehicle) and connecting a source of electrical power and control signals between the vehicle and the thermal management module.

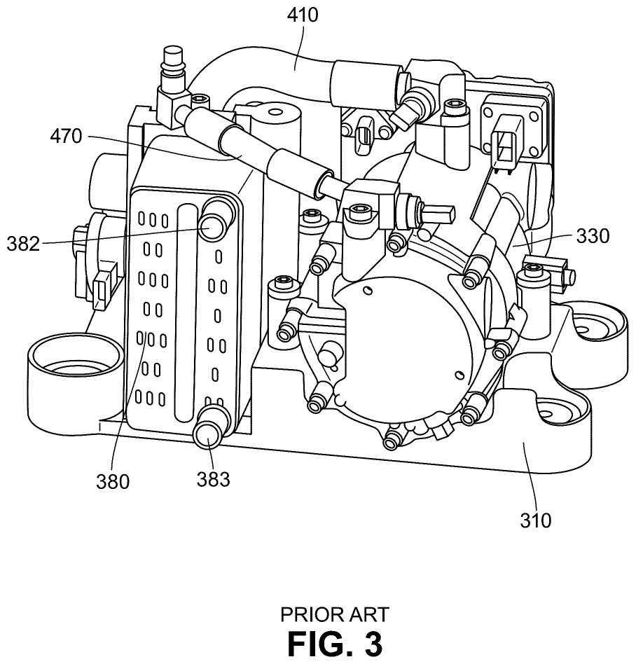

FIG. 3 depicts a prior art thermal management module with a housing 310 that supports a compressor 330, a condenser 380, and a chiller (not shown in the view of FIG. 3, which performs the function of an evaporator in typical refrigeration systems). The housing supports these components, and the thermal management module includes the refrigerant flow paths within the thermal management module, e.g. a first tube 470 that extends from a discharge of the compressor 330 and to an inlet of the condenser 380, and a second tube 410 that extends from the chiller (not shown) and to an inlet of the compressor 330. The thermal management module also has inlet and outlet connections 382, 383 for connection to a vehicle coolant system with the condenser 470 380 to allow for heat to be added to coolant that flows into the condenser (via inlet connection 382) and the outlet that allows the heated coolant to flow to the loads within the vehicle that use the coolant system. Similar coolant connections are on the chiller to allow heat from the coolant system to be transferred to the refrigerant system. The refrigerant flow paths (e.g. 410, 470) are typically hoses or pipes that are connected to the components within the thermal management module as the module is being assembled.

FIGS. 1-2 depict a thermal management module 10 that improves upon the prior art versions. The module includes a housing 20 that supports and encloses the components of the thermal management module and provides for the connections to the auxiliary systems that are provided to the thermal management module 10, such as a vehicle coolant system, the electrical power distribution system, and a control system (1000, schematic, which may be the control system that operates the HVAC system, a dedicated control system for the thermal management module, or an overall vehicle control system) that operates the thermal management module 10. The housing is provided both as a support structure for the components and as discussed in greater detail below, establishes the various refrigerant flow paths within the thermal management module. The thermal management module 10 is provided to allow the module to be installed virtually anywhere within a vehicle and the housing protects the components therewithin from interfering with or being interfered by other components within the vehicle, such as rotating components, significantly hot components, components that that are subject to significant wind, and the like.

A cross-sectional view of the thermal management module 10 is provided in FIG. 1. The module includes all of the components for a complete refrigeration cycle (or heat pump), and maintains them in position to minimize the distance therebetween the various components (thereby limiting the volume of refrigerant that is needed within the thermal management module and limiting the heat transfer into or out of the refrigerant as the refrigerant flows between the various components of the system, which reduces the efficiency of the overall module. The module also includes fluid flow channels that are integrally formed within the housing, which eliminates many of the fluid connections within a conventional thermal management module (for example the two connections to the hose 470 between the compressor 330 discharge and the condenser 380 as depicted in FIG. 3, which may be sources of fluid leaks due to extended operation, improper assembly, or damage due to external factors. The presence of internal channels within the housing 20 (as discussed in more detail below) eliminate many of the possibilities of failure at fluid connections. HVAC systems for vehicles are recently being designed to use flammable refrigerants due to various beneficial properties (e.g. good thermal capacity, and the lack of harm to the environment associated with other conventional refrigerants), such as propane (R-290) and leakage from external pipes and hoses or leakage at connections between the external pipes or hoses and the components of the system can create hazards such as fires or explosions. The enclosure of all of the internal channels for systems with flammable refrigerants makes these designs an improvement over conventional thermal management module designs with external refrigerant pipes or hoses that must be connected to the various components of the system.

The presence of internal channels within the housing 20 also prevents or minimizes any external factors from influencing the volume of flow through the channels, either decreasing due to external components crimping or compressing of external flow tubes/pipes which minimizes the size of the refrigerant flowpath within the tube/pipe.

FIG. 1 depicts the components within the thermal management module 10. A housing 20 is provided and supports and encloses the components as well as the various refrigerant fluid flow channels. The module 10 includes a compressor 30 that typically includes a motor 32 that rotates a shaft 34 (arrow R) that rotates one or more stages that serve to raise the pressure of the refrigerant entering the compressor so that it leaves the compressor 30 (specifically the compressing section 36) as a high pressure gas. A first flow channel 210 is connected between a discharge 36a of the compressor (discharge of the final stage for a multi-stage compressor 36) to an inlet 44 of the condenser 40.

In some embodiments, the item that performs the condensing function 40 (i.e. reduce heat of the refrigerant by giving off heat to the coolant that flows therethrough) typically results in the refrigerant received by the item changing from a superheated vapor to a saturated vapor or sometimes liquid/vapor mix. In some embodiments where the refrigerant is always a gas throughout the cycle (e.g. carbon dioxide systems) the component that performs the function of the condenser is often referred to as a gas-cooler because the refrigerant remains a gas through the gas-cooler (i.e. the gas does not condense to a liquid within the gas-cooler). The operation and construction of the housing 20 and related components when the component that removes energy is the a gas cooler (due to the type of refrigerant that the thermal management module 10 is designed to receive) is the same as the construction of the housing and the related components when the component is a condenser, unless specific differences are noted herein. For the sake of brevity components that condense refrigerants as well as gas coolers (that remove heat but the refrigerant is maintained as a gas) are referred to as a condenser 40 herein.

In some embodiments, the condenser 40 may receive a flow of coolant from a coolant system within a vehicle, with coolant flowing into the condenser 40 through the inlet 42 (flow W) and leaving the condenser 40 through the outlet 43 (flow X). The coolant that enters the condenser receives heat from the refrigerant, which is given off in the form of the latent heat of condensation as the high pressure and high temperature gas (often superheated) becomes initially saturated vapor and then condenses to mixture of gas and liquid. The heat given off from the refrigerant is transferred to the coolant such that the temperature of the coolant leaving the condenser (X) is higher than the temperature of the coolant entering the condenser (W).

In some embodiments, the system 10 includes a subcooler (or intercooler) 60 where refrigerant leaving the condenser 40 flows across a component where refrigerant from the receiver/dryer 50 flows, with heat exchanged across the subcooler 60. A second flow channel 220/230 extends from the outlet of the condenser 45 to the receiver/dryer 50.

The receiver/dryer is formed within the housing and receives refrigerant from the condenser 40. If there is a subcooler the receiver/dryer 50 in the system receives the refrigerant flow from the condenser 40. If there is not a subcooler in the system the refrigerant flows directly to the receiver/dryer 50. The receiver/dryer 50 may include an expansion volume for refrigerant, which may retain refrigerant within the system that is not currently needed to flow through the circuit. The receiver/dryer 50 may include a desiccant to remove water that is entrained with the refrigerant, and may include a filter for removing debris from within the refrigerant.

Refrigerant leaves the receiver/dryer 50 via a fourth flow channel 240 that extends from the receiver/dryer 50 to the subcooler 60, discussed above. Refrigerant then flows through a fifth flow channel 250 to the expansion valve 70. In some embodiments, the housing 20 does not include a subcooler 60, and the refrigerant flows directly from the condenser 40 to the receiver/dryer 50 and then to the expansion valve 70 via a flow path that extends between the refrigerant outlet of the receiver/dryer 50 to the expansion valve 70. As is well known, the expansion valve 70 reduces the pressure of the refrigerant and allows the refrigerant to change phase to a gas/liquid mixture (in systems with a refrigerant that changes phase during the cycle between liquid and gas). Refrigerant leaves the expansion valve 70 and flows to the chiller 80 via a sixth flow channel 260.

The chiller 80 receives a flow of coolant from the vehicle's coolant system, with the coolant flowing into the chiller inlet 82 (flow Y) and the coolant flowing out the chiller outlet 83 (flow Z). As is well known, the low pressure mixture of liquid and gas refrigerant enters the chiller 80. The refrigerant receives heat from the coolant, which causes the low pressure refrigerant to turn to vapor therein. The heat transfer reduces the temperature of the coolant such that the temperature of the coolant leaving the chiller 80 (flow Z) is less than the temperature of coolant entering the chiller (flow Y).

Refrigerant (which is low pressure vapor at the exit of the chiller 80) flows to the compressor inlet via the seventh flow path 270 and the cycle continues. The controller controls the operation of the compressor (speed and duty cycle) to control the circulation of the refrigerant through the housing 20 as discussed herein.

The housing 20 includes an enclosure that receives the compressor 30 and specifically the motor 32 and the various stages of a compression section 36 within the compressor 30 that are operated by the motor 32. The housing 20 includes an enclosure where the receiver/dryer 50 (when provided) is provided. The housing includes an enclosure where the expansion valve 70 is provided.

In some embodiments, the housing 20 includes the condenser 40, while in other embodiments, the condenser 40 is rigidly mounted to the housing. In an embodiment where the condenser is rigidly mounted to the housing 20, the first flow channel 210 aligns with an inlet 44 of the condenser 40 when the condenser is properly positioned upon the housing 20. Similarly, the second flow path 220 (condenser to the receiver/dryer 50) within the housing 20 aligns with the condenser outlet 45. In an embodiment when the subcooler 60 is not provided, the flow path 220/230 from the condenser to the receiver/dryer 50 within the housing 20 is aligned with the condenser outlet 45 when the condenser 40 is properly positioned upon the housing 20. In still further embodiments where refrigerant flows directly from the condenser 40 to the expansion valve 70, that flow path within the housing is aligned with the condenser outlet 45 when the condenser 40 is properly positioned upon the housing.

In some embodiments, a gasket is provided between the housing 20 and the condenser 40 to prevent leakage along a seam between the two components. Other known structures to prevent leakage may be provided.

In some embodiments, the housing 20 includes the chiller, while in other embodiments, the chiller is rigidly mounted to the housing 20. In an embodiment where the chiller is rigidly mounted to the housing 20, the sixth flow channel 260 aligns with an inlet 84 into the chiller when the chiller 80 is properly positioned upon the housing 20. Similarly the seventh flow path 270 (chiller to compressor inlet) within the housing 20 aligns with the chiller outlet. As with the condenser, a gasket may be provided between the housing 20 and the chiller 80 to prevent leakage along a seam between the two components. Other known structures to prevent leakage may be provided.

One or both of the condenser 40 and the chiller 80 may be constructed with a plurality of parallel plates, wherein refrigerant and coolant flow between separated spaces between adjacent parallel plates. In other embodiments, one or both of the condenser 40 or the chiller 80 may be constructed with a tube and shell construction. Other types of heat exchangers to be used for the condenser 40/chiller 80 may be provided, including types of condensers and chillers that are maintained within a housing (e.g. the housings 49 and 89 discussed herein). The term “parallel plates” is defined with respect to the formation of the condenser 40 and/or the chiller 80 such that the plates are aligned with a consistent spacing between adjacent plates along their lengths, such that a line that extends through a first plate is parallel or substantially parallel with a line that extends through an adjacent plate. The term parallel in this instance does not require that the line through any plate be a straight line—the line can be a straight line, a curved line, or a line with multiple portions, such as several straight portions that are at angles to each other, or a straight portions that extend to curved portions, or the like. The term substantially parallel includes lines that are exactly parallel as well as lines that divert from being exactly parallel with each other a small amount, such as by no more than 20 degrees.

FIG. 1 depicts a side cross-sectional view of the housing 20 and the first through seventh flow paths 210-270 that collectively form the refrigerant circuit. As depicted in the Figure, each of the flow paths extend in a straight line along a respective longitudinal axis of the respective flow path. In some embodiments, the entire length of one, some, or all of the flow paths extend along a straight longitudinal axis through the respective flow path. In other embodiments, one, some, or all of the flow paths extend along the respective straight longitudinal axis for an overwhelming majority of the length of the respective flow path. The term overwhelming majority is defined herein to include the entire length of the flow path as well at least 75% of the total length of the flow path. In embodiments where a portion of the flow path does not extend along the straight longitudinal axis, the curve portion is curved with a gradual curve (and/or a larger diameter along the curved portion) to minimize any excess head loss through the curved portion. The flow paths may be formed with a constant diameter along the portions that extend along the straight longitudinal axis.

The flow paths 210, 220, 230, 240, 250, 260 and 270 are formed within the housing. In some embodiments, one, some, or all of the flow paths are formed by portions of the housing 20 and are formed integrally with the housing 20. For example, in these embodiments, the flow paths that are formed by portions of the housing may be formed by machining the flow paths within the housing, such as by drilling the flow path within the housing 20. In the embodiments where the flow paths are formed integrally with the housing 20, the flow paths are not prone to leakage as often occurs with flow paths that include external hoses or tubes that are fixed to connections to the components with the housing 20.

In some embodiments, the cyclic refrigerant flow (as urged by the operation of the compressor 30) within the housing 20 from the compressor 30, to the condenser 40, in some embodiments to the receiver/dryer 50, to the expansion valve 70, to the chiller 80, and returning to the compressor 30. In some embodiments to the receiver/dryer 50 and returning to the subcooler 60, to the expansion valve 70, to the chiller 80, and returning to the compressor 30 is provided without any pipes or hoses that are not integrally formed within the walls of the housing 20. In this embodiment, the housing 20 is taken to include the condenser housing 49, the subcooler housing 69, and the chiller housing 89 when any of those components are formed as separate housings that are fixed to the housing 20. If the compressor 30 unit itself has any pipes or hoses that are part of the compressor, that is consistent with the housing not having any pipes or hoses where refrigerant flows to or from the compressor. In other embodiments, the refrigerant cyclically flows from the condenser 40, to the receiver/dryer 50, and then to the expansion valve 70 via a direct flow path (not shown, similar to flow path 250 in FIG. 1), and in this embodiment the cyclic flow path is provided without any pipes or hoses that are not integrally formed with the walls of the housing.

In embodiments where the condenser 40 and/or the chiller 80 are formed as separate components to the housing 20 but fixed to the housing, the fluid connection between the sixth flow channel (260—from the expansion valve 70 to the chiller inlet 84) may be with the sixth flow channel 260 and an inlet of the chiller 80 that is integrally formed with the chiller housing 89, which mates to the sixth flow channel 260 when the chiller housing 89 is properly connected to the housing 20. Similarly, the seventh flow path 270 (from the chiller outlet 85 to the compressor 30 inlet) the fluid connection between the seventh flow path 270 and the chiller outlet 85 is mated when the chiller housing 89 is properly connected to the housing 20.

Similarly, in embodiments where the condenser is within a condenser housing 49 that mates with the housing 20, the first flow channel 210 (from compressor outlet to the condenser inlet 44) mate together when the condenser housing 49 is properly connected to the housing 20. Also, the second flow path 220 (condenser to the receiver/dryer 50) mates with the condenser outlet 45 when the condenser housing 49 is properly connected to the housing. In some embodiments, the subcooler 60 may be integrally formed within the housing 20. The subcooler 60 may include multiple parallel plates that establish a plurality of flow channels for the flow from the refrigerant flows through the subcooler 60 (a first flow of coolant (from the coolant inlet flow W and a second flow of refrigerant directly from the receiver/dryer 50)). In other embodiments, the subcooler 60 may be a separate housing 69 that fixably mates directly to the housing 20, and with the condenser fixably mates directly to the subcooler 60. In this embodiment, the second flow path 220 is integrally formed within the subcooler housing 69. In this embodiment, the subcooler housing 69 includes a flow path 210a that forms a portion of the first flow path 210 (from the compressor outlet to the condenser inlet 44) to flow therethrough. In this embodiment the flow path 210a mates directly with the first flow path 210 (through the housing 20) and the condenser inlet 44 when the subcooler housing 69 is properly fixedly positioned upon the housing 20 and when the condenser housing 49 is properly fixedly positioned upon the subcooler housing 69.

In embodiments where the subcooler 60 has a separate housing 69 from the housing 20, when the subcooler housing 69 is properly fixedly positioned upon the housing 20 the both the fourth flow path (240—receiver/dryer 50 to the subcooler 60) and the fifth flow path (250—subcooler 60 to the expansion valve 70) mate with respective inlets into the subcooler housing 60 to allow the refrigerant flow from the receiver/dryer 50 to enter the subcooler 60 and flow therethrough and then return to the housing via the fifth flow path 250, with these connections fixably mating when the subcooler housing 69 is properly connected to the housing 20.

FIG. 2 is a cross-sectional view of the housing and depicts several of the flow paths. In the figure, the third flow path 230 is provided, which flows from the subcooler 60 to the receiver/dryer. The view further shows the fourth flow path 240, the fifth flow path 250, and the first flow path 210. The view shows the motor 32 of the compressor.

In some embodiments, the housing 20 includes an electronics module 120 that is fixed thereto, or may be formed integrally with the housing 20. The electronics module 120 is configured to receive electrical power (such as DC power from the vehicle's battery, not shown, or in some embodiments AC power from the vehicle's alternator) that is used to power the compressor motor 32. In embodiments wherein DC current is received by the electronics module 120, the electronics module includes an inverter, which converts DC current to AC current (needed for a compressor that runs from a AC motor). The electronics module 120 also receives control signals from the HVAC or vehicle controller (not shown) that provides control signals to control the operation of the compressor according to the needs of the HVAC system or the needs of the coolant system. The housing 20 comprises a plurality of electrodes that mate with corresponding electrodes upon the electronics module 120 to establish one or more electrical flow paths between the electronics module 120 and the housing 20 when the electronics module 120 is properly fixedly mated to the housing 20, which establish one or more electrical flow paths between the housing 20 and the electronics module—for current to flow to power the compressor motor 32 and for control signals to pass to control the operation of the compressor 30. In some embodiments, the control signals are only received within the electronics module 120 and the current is supplied to control the compressor motor 32, but no separate control signals are separately passed to the compressor 30 from the electronics module 120.

The term “about” is specifically defined herein to include a range that includes the reference value and plus or minus 5% of the reference value. The term “substantially the same” is when the item under comparison is within 5% of the aspect of the reference value of the item.

The computing elements or functions disclosed herein such as the vehicle or HVAC controller and the electronics module 120 may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The subject specification may be readily understood with reference to the following Representative Paragraphs:

Representative Paragraph 1: A thermal management module, comprising:
a housing that encloses a compressor, the housing fixedly retaining a condenser, an expansion device, and a chiller,
wherein the housing integrally forms a plurality of flowpaths within the housing that are configured for refrigerant to flow therethrough, including a first flow path from a discharge of the compressor to an inlet of the condenser, a second flow path from the expansion device to an inlet of the chiller, and a third flow path from the chiller to a suction of the compressor, wherein each of the first flow path, the second flow path, and the third flow path are each integrally formed within the housing.

Representative Paragraph 2: The thermal management module of Representative Paragraph 1, further comprising a receiver/dryer that is enclosed within the housing, and a fourth flow path from an outlet of the condenser to the receiver/dryer, wherein the fourth flow path is integrally formed within the housing.

Representative Paragraph 3: The thermal management module of Representative Paragraph 2, further comprising a subcooler with an inlet that receives flow from the receiver/dryer and an outlet that sends flow to the expansion valve, and further comprising a fifth flow path from the receiver/dryer to the inlet of the subcooler, and a sixth flow path from the outlet of the subcooler to the expansion valve, wherein the fifth flow path and the sixth flow paths are integrally formed within the housing.

Representative Paragraph 4: The thermal management module of Representative Paragraph 3, wherein the subcooler includes a second inlet that receives flow from the condenser and a second outlet that sends flow to the receiver/dryer, the fourth flow path includes a first portion where refrigerant flows from the condenser outlet to the subcooler and a second portion where refrigerant flows from the subcooler to the receiver/dryer.

Representative Paragraph 5: The thermal management module of any one of Representative Paragraphs 1-4, wherein the condenser has a coolant inlet and a coolant outlet, wherein a flow of coolant flows through the condenser via the coolant inlet and the coolant outlet of the condenser.

Representative Paragraph 6: The thermal management module of any one of Representative Paragraphs 1-5, wherein the chiller has coolant inlet and a coolant outlet, wherein a flow of coolant flows through the chiller via the coolant inlet and the coolant outlet of the chiller.

Representative Paragraph 7: The thermal management module of any one of Representative Paragraphs 2-6, wherein the condenser is fixed to the housing such that a refrigerant inlet of the condenser makes a fluid connection with the first flow path, and wherein a refrigerant outlet of the condenser makes a fluid connection with the fourth flow path.

Representative Paragraph 8: The thermal management module of any one of Representative Paragraphs 1-7, wherein the chiller is fixed to the housing such that a refrigerant inlet of the chiller makes a fluid connection with the second flow path, and wherein a refrigerant outlet of the chiller makes a fluid connection with the third flow path.

Representative Paragraph 9: The thermal management module of any one of Representative Paragraphs 1-8, wherein the cyclic refrigerant flow within the housing from the compressor, to the condenser, ultimately to the expansion device, to the chiller and returning to the compressor is provided without any pipes or hoses that are not integrally formed by walls of the housing.

Representative Paragraph 10: The thermal management module of any one of Representative Paragraphs 1-9, wherein one or more of the first flow path, the second flow path, and the third flow path are aligned along a respective straight longitudinal axis for at least an overwhelming majority of a length of the respective flow path.

Representative Paragraph 11: The thermal management module of Representative Paragraph 10, wherein all of the first flow path, the second flow path, and the third flow path are aligned along the respective straight longitudinal axis for at least the overwhelming majority of the length of the respective flow path.

Representative Paragraph 12: The thermal management module of Representative Paragraph 10, wherein the one or more of the first flow path, the second flow path, and the third flow paths are aligned along the straight longitudinal axis for the entire length of the respective flow path.

Representative Paragraph 13: The thermal management module of Representative Paragraph 2, wherein the fourth flow path is aligned along a straight longitudinal axis for at least an overwhelming majority of a length of the fourth flow path.

Representative Paragraph 14: The thermal management module of any one of Representative Paragraphs 1-13, wherein the condenser is constructed with a plurality of parallel plates, and the chiller is constructed with a plurality of parallel plates.

Representative Paragraph 15: The thermal management module of any one of Representative Paragraphs 1-14, further comprising an electronics module that is fixed to the housing, the electronics module is configured to receive electrical current to operate the compressor.

Representative Paragraph 16: The thermal management module of Representative Paragraph 15, wherein the electronics module comprises an inverter to convert received DC current to AC current for powering the compressor.

Representative Paragraph 17: The thermal management module of any one of Representative Paragraphs 1-16, wherein the housing comprises one or more electrodes that mate with corresponding electrodes upon the electronics module to establish one or more electrical flow paths between the housing and the electronics module when the electronics module is fixed to the housing.

1. A thermal management module, comprising:
a housing that encloses a compressor, the housing fixedly retaining a condenser, an expansion device, and a chiller,
wherein the housing integrally forms a plurality of flowpaths within the housing that are configured for refrigerant to flow therethrough, including a first flow path from a discharge of the compressor to an inlet of the condenser, a second flow path from the expansion device to an inlet of the chiller, and a third flow path from the chiller to a suction of the compressor, wherein each of the first flow path, the second flow path, and the third flow path are each integrally formed within the housing.

2. The thermal management module of claim 1, further comprising a receiver/dryer that is enclosed within the housing, and a fourth flow path from an outlet of the condenser to the receiver/dryer, wherein the fourth flow path is integrally formed within the housing.

3. The thermal management module of claim 2, further comprising a subcooler with an inlet that receives flow from the receiver/dryer and an outlet that sends flow to the expansion valve, and further comprising a fifth flow path from the receiver/dryer to the inlet of the subcooler, and a sixth flow path from the outlet of the subcooler to the expansion valve, wherein the fifth flow path and the sixth flow paths are integrally formed within the housing.

4. The thermal management module of claim 3, wherein the subcooler includes a second inlet that receives flow from the condenser and a second outlet that sends flow to the receiver/dryer, the fourth flow path includes a first portion where refrigerant flows from the condenser outlet to the subcooler and a second portion where refrigerant flows from the subcooler to the receiver/dryer.

5. The thermal management module of claim 1, wherein the condenser has a coolant inlet and a coolant outlet, wherein a flow of coolant flows through the condenser via the coolant inlet and the coolant outlet of the condenser.

6. The thermal management module of claim 1, wherein the chiller has coolant inlet and a coolant outlet, wherein a flow of coolant flows through the chiller via the coolant inlet and the coolant outlet of the chiller.

7. The thermal management module of claim 2, wherein the condenser is fixed to the housing such that a refrigerant inlet of the condenser makes a fluid connection with the first flow path, and wherein a refrigerant outlet of the condenser makes a fluid connection with the fourth flow path.

8. The thermal management module of claim 1, wherein the chiller is fixed to the housing such that a refrigerant inlet of the chiller makes a fluid connection with the second flow path, and wherein a refrigerant outlet of the chiller makes a fluid connection with the third flow path.

9. The thermal management module of claim 1, wherein the cyclic refrigerant flow within the housing from the compressor, to the condenser, ultimately to the expansion device, to the chiller and returning to the compressor is provided without any pipes or hoses that are not integrally formed by walls of the housing.

10. The thermal management module of claim 1 wherein one or more of the first flow path, the second flow path, and the third flow path are aligned along a respective straight longitudinal axis for at least an overwhelming majority of a length of the respective flow path.

11. The thermal management module of claim 10, wherein all of the first flow path, the second flow path, and the third flow path are aligned along the respective straight longitudinal axis for at least the overwhelming majority of the length of the respective flow path.

12. The thermal management module of claim 10, wherein the one or more of the first flow path, the second flow path, and the third flow paths are aligned along the straight longitudinal axis for the entire length of the respective flow path.

13. The thermal management module of claim 2, wherein the fourth flow path is aligned along a straight longitudinal axis for at least an overwhelming majority of a length of the fourth flow path.

14. The thermal management module of claim 1, wherein the condenser is constructed with a plurality of parallel plates, and the chiller is constructed with a plurality of parallel plates.

15. The thermal management module of claim 1, further comprising an electronics module that is fixed to the housing, the electronics module is configured to receive electrical current to operate the compressor.

16. The thermal management module of claim 15, wherein the electronics module comprises an inverter to convert received DC current to AC current for powering the compressor.

17. The thermal management module of claim 1, wherein the housing comprises one or more electrodes that mate with corresponding electrodes upon the electronics module to establish one or more electrical flow paths between the housing and the electronics module when the electronics module is fixed to the housing.
